(19) United States
(12) Patent Application Publication
(10) Pub. No.: US 2009/0094139 A1
(43) Pub. Date: Apr. 9, 2009

(54) MYCONCERTDATE.COM

(76) Inventors: Quang Regan, Las Vegas, NV (US); Damian Kiraly, Las Vegas, NV (US)

Correspondence Address: HOWARD & HOWARD ATTORNEYS PLLC, 450 West Fourth Street, Royal Oak, MI, 48067, US

(21) Appl. No.: 12/245,238

(22) Filed: Oct. 3, 2008

Related U.S. Application Data
(60) Provisional application No. 60/977,724, filed on Oct. 5, 2007.

(51) Int. Cl. G06Q 30/00

(52) U.S. Cl. 705/27

(57) ABSTRACT

A method for a member of an organization whose purpose is to bring people together who share common interests, wherein each member posts, on a common website, a profile describing themselves and their interests; where each member may list on the website one or more tickets to an entertainment event for sale, trade or date; each member being able to directly contact, through an electronic portal, the member posting the tickets, to purchase, trade or arrange a date to attend the event with the posting member, if both members agree.

### FIELD OF THE INVENTION

This application claims the benefit of U.S. Provisional Application Ser. No. 60/977,724, filed Oct. 5, 2007, which application is incorporated herein by reference in its entirety.

### BACKGROUND OF THE INVENTION

In the arena of online dating, there are countless websites that promise to find consumers true love based on complicated formulas and drawn-out personality profiles. However, there is no proven scientific approach to identifying personal chemistry between two people. To solve this problem, MyConcertDate.com has created a revolutionary concept in dating, by bringing people with common entertainment interests together. MyConcertDate.com is designed for busy individuals that enjoy meeting new people that share the same music, sports and/or cultural interests.

One online social and dating system is disclosed in U.S. Pat. No. 7,246,067 (the '067 patent), the disclosure of which is incorporated by reference in its entirety. The '067 patent discloses provides a secure system which requires potential members to disclose personal information prior to becoming members.

Another social system is disclosed in US Patent Application Publication 2006/0143214; Ser. No. 11/344,816 (the '816 application), the disclosure of which is incorporated in its entirety. The '816 application discloses a method and apparatus which allows for members to arrange social meetings. The arranged social meetings may be between individuals, groups (such as families), etc . . . . In one aspect the arranged social meeting may be centered on a particular entertainment event, such as a concert or movie. Typically, such would be for a specific time and day, e.g., a showing of a particular movie on a specific day and time. Once a social meeting has been arranged the social system, of the '816 application may arrange or facilitate the purchase of tickets to the event, e.g., by linking to another or external website at which the tickets may be purchased. However, there is no guarantee that after the social meeting has been arranged that tickets for the event will be available, i.e., that the event will not be sold out. Additionally, even after the social meeting is arranged, there is no guarantee that tickets will be purchased.

The present invention is aimed at one or more of the problems identified above.

### SUMMARY OF THE INVENTION

MyConcertDate.com uses a communication, factoring and feedback system to couple users and allow them to meet other users in a social environment, based on a shared common interest in music, sports, or any other form of entertainment (“Event Based Coupling”).

MyConcertDate.com allows users to become “members” and post profile data describing themselves and their interests. Members can list tickets to an entertainment event for sale, trade, or date. Members can communicate through the MyConcertDate.com communication portals, evaluate other Members' profiles to identify Members with shared common interests and possibly with whom they would choose to attend an entertainment event. Once two Members attend an event together, Members can leave feedback, in the form of an opinion, as to the nature of the sale, trade or dating experience, as well as the character of the other Member.

Although other websites claim to have a formula for love, there is no proven scientific approach to identifying chemistry. MyConcertDate.com utilizes a systematic process to effectuate Event Based Coupling. MyConcertDate.com, through a software program, analyzes Member profile data to determine which Members are compatible based on certain factors, including, without limitation, those Members' shared common interests, location, and age (“Compatibility Determination”). If a Member has an event ticket and requests a date candidate, MyConcertDate.com will effectuate a Compatibility Determination to determine the most compatible Member date candidates for such Member.

### DETAILED DESCRIPTION OF INVENTION

Elements of the MyConcertDate.com Website (the “Website”).

1) An electronic portal through which any Internet user (“User”) can post profile data in a structured format (with certain free form areas) and, after agreeing to certain terms and conditions of the Website, Users become members of the Website (“Members”) and can perform a keyword indexing search (“Search”) of all User profiles, as well as initiate the Website's Compatibility Determination to effectuate Event Based Coupling.

2) A Member can list an entertainment event ticket (“Ticket”) for sale, trade or date.

a) Listing Requirements:

b) To list a Ticket, a Member must submit a Ticket listing to the Website and select an event from the main list of events (the “Event List”) or create a new event, which MyConcertDate.com will then add to the Event List (for standardization and ease of use purposes with respect to the searchable database). b) Offer to sell: option to post Ticket at a fixed price or auction.

c) Offer to invite a trade/barter.

d) Offer Ticket for a date candidate: User can evaluate candidates (candidates must be Members).

3) Searches for Tickets or Members.

a) User can Search for Tickets by title or genre, event type, or location.

b) Members can view or contact the member who has posted a ticket to a particular event. Only Members can contact the Member who lists the Ticket.

c) Members can establish a “want list” whereby certain event parameters are selected by a Member and every time another Member posts a Ticket for an event satisfying the parameters of that Member's want list, such member is notified of the Ticket listing.

d) Members can Search for other Members by keyword(s) to identify Members with similar interests.

e) Members can limit the searches to only those Members who are currently logged in to the Website.

4) User can purchase Tickets and MP3's directly from MyconcertDate.com.

a) MyConcertDate.com is an authorized Ticket broker and accepts credit card payments for Tickets listed by MyConcertDate.com on the Website.

b) MyConcertDate.com accepts credit card payments for the purchase of sound and video recordings (currently in MP3 format) that can be downloaded from the Website for a certain fee.

5) Communication conduit.

a) There is an Intranet for Members to post secured and private email type communications.

b) Communications can be posted to a Member's profile by another Member who initiates a “buzz” by clicking on the “buzz button” located on each Member's profile page, which then allows such Member to leave a comment which all Users can view as part of the real-time intranet Website community. A Member can delete comments from such Member's profile as such Member desires. The purpose of comments is to give Members a forum to describe their feelings toward and/or experiences with another Member, which can be instrumental in helping other Members select a potential date candidate.

c) There is a Public posting forum viewable by all Users.

d) Chat Rooms or “Tek Bars” are available where Members can engage in real-time communications. Tek Bars consist of virtual bars whereby Members “sit” at virtual stools and have the ability to (i) interface with other Members who are “sitting” in such Tek Bar, (ii) invite other Members to such Tek Bar and (iii) purchase virtual items, such as digital flowers, for other Members at the Tek Bar. Tek Bars are formed by Members and titled by Members based on a theme or a common interest, for example, a city, a musical group or a sports team.

e) Members can invite other Members to a specific Tek Bar where such Members can participate in contests and the inviting Member can evaluate participating Members for the purpose of selecting a date.

6) Feedback component.

a) Members can leave feedback for another Member after completing a transaction with such Member ie; purchase and sale, trade or date.

b) Feedback consists of a rating system as well as a free form comment section.

c) Members can purchase a digital flower from Myconcertdate.com for another Member and such digital flower is then posted on the receiving Member's profile.

d) Members can purchase a sound or video recording (currently in MP3 format) for another Member and such sound or video recording is then posted on the receiving Member's profile.MyConcertDate.com provides a unique way for one person to meet another person with a common entertainment interest, which has proven to be a positive method of finding a compatible date. After the first meeting, the rest is up to the individuals.

7) Common Interest Group

In one aspect of the present invention, a member may create a group based on common interests and other members may join the group. Exemplary may include, for example, “The Country Music Fan Club”, “The Chicago Cubs Maniacs”, or “The Rolling Stones Groupies”. Group administrators can invite other members to join their group. Members can join existing groups.

8) Members linked as Friends

In another aspect of the present invention, members may request that they be linked to other members as “friends”. There may be particular parts or information of a member's profile which is viewable only by friends.

The present invention has been described above with reference to preferred embodiments. However, those skilled in the art will recognize that changes and modifications may be made in these preferred embodiments without departing from the scope of the present invention.

Obviously, many modifications and variations of the present invention are possible in light of the above teachings. The invention may be practiced otherwise than as specifically described within the scope of the appended claims.

What is claimed is:

1. A method for members of an organization to meet other members who share common interests wherein:
each member posts on a common website, a profile describing themselves and their interests;
wherein each member may list on the website one or more tickets to an entertainment event for sale, trade or date; and,
wherein each member may directly contact, through an electronic portal, the member posting the tickets, to purchase or trade the tickets or arrange a date to attend the event with the posting member, if both members agree.

2. The method of claim 1 in which each member can post feedback on the website, as to the sale, trade or date experience.

3. The method of claim 1 in which each member can post feedback on the other member who joined in the sale, trade or date.

4. The method of claim 1 in which, if a member posts an event ticket and requests a date, said organization conducts a compatibility study to determine the most compatible member date candidates for the posting member.

5. The method of claim 1 in which the organization posts a list of entertainment events for which a member can list a ticket for sale, trade or date.

6. The method of claim 1 in which the member may offer one or more tickets for sale at a fixed price or auction.

7. The method of claim 4 in which the member offering a ticket for a date can evaluate the profiles of date candidates selected by the organization.

8. The method of claim 7 in which the member offering a ticket for a date can contact any date candidate directly through an electronic portal available to members only.

9. The method of claim 1 in which a member may post a list of entertainment events in which they are interested and if another member posts tickets to one of the listed events, the listing member is automatically notified of the ticket posting.

10. The method of claim 1 in which members can search for other members by keywords to identify members with common interests.

11. The method of claim 1 in which the organization acts as a ticket broker for events.

12. The method of claim 11 in which the organization accepts credit cards of members for payment for tickets to events.

13. The method of claim 1 in which members may contact each other over a secure intranet.

14. The method of claim 13 in which members can post communications to a member's profile by clicking on a buzz button which allows said member to post a comment which all members can view as part of the intranet.

15. The method of claim 14 in which a member can delete comments posted on their profile.

16. The method of claim 13 in which members can engage in real time communication at tek bars available on the intranet.

17. The method of claim 16 in which the tek bars are based on a theme, such as a city, a musical group, a sports team or other themes.

18. The method of claim 1 in which members can purchase a digital flower to be sent and posted to a receiving member's profile.

19. The method of claim 1 in which members can purchase a sound or video recording to be sent and posted to a receiving member's profile.

20. The method of claim 1 in which a member can create a group based on common interests and other members may join the group.

21. The method of claim 1 in which members may link to other members as friends.

22. The method of claim 1 in which members may search a listing of event tickets posted by other members and view the profile of a member who has posted a particular event ticket.
